(19) United States
(12) Patent Application Publication
(10) Pub. No.: US 2003/0049532 A1
(43) Pub. Date: Mar. 13, 2003

(54) Negative electrode for lithium battery and lithium battery

(76) Inventors: Hiroshi Kurokawa, Yawata-shi (JP); Kenji Asaoka, Sumoto-shi (JP); Miho Onaka, Kobe-shi (JP); Taeko Ota, Mishima-gun (JP); Maruo Kamino, Kobe-shi (JP)

Correspondence Address: KUBOVCIK & KUBOVCIK, SUITE 710, 900 17TH STREET NW, WASHINGTON, DC, 20006

(21) Appl. No.: 10/183,633

(22) Filed: Jun. 28, 2002

(30) Foreign Application Priority Data
Jun. 28, 2001 (JP) 2001-195863

(51) Int. Cl. H01M 4/58; H01M 2/02

(52) U.S. Cl. 429/231.4; 429/232; 429/176

(57) ABSTRACT

A negative electrode for a lithium battery includes a carbon material capable of occluding and discharging lithium and an additive material having a higher potential to discharge lithium than the carbon material, wherein the additive material is contained in a range of 0.01-9.0 weight % based on the weight of the carbon material, an average particle diameter of the carbon material is in a range of 0.01-50 μm, and an average particle diameter of the additive material is in a range of 0.01-50 μm. A lithium battery of the invention includes the negative battery.

### FIELD OF THE INVENTION

The present invention relates to a negative electrode for a lithium battery and a lithium battery having the negative electrode. Furthermore, the present invention relates to a negative electrode including a carbon material to prevent reaction between the negative electrode and a nonaqueous electrolyte during storage under a condition that the lithium battery is discharged.

### BACKGROUND OF THE INVENTION

A lithium battery has recently been used as a new type battery having a high output and high energy density.

A metal lithium, lithium alloy including Li—Al alloy or the like, and a carbon material which can occlude and discharge lithium have been used as a negative electrode material of a lithium battery.

When a lithium battery comprising metal lithium in a negative electrode is charged and discharged, there is a problem of occurrence of dendrite on the surface of the negative electrode.

When a lithium alloy, for example, Li—Al alloy or the like is used in a negative electrode, it is possible to prevent occurrence of dendrite. However, the alloy does not have flexibility, and it is difficult to handle when it is used in the form of a powder because lithium alloy reacts quickly. A lithium battery having a lithium alloy as a negative electrode is charged and discharged and the lithium alloy is contracted or shrunk to increase stress in inside of the lithium alloy. When the battery is repeatedly charged and discharged, the lithium alloy disintegrates and capacity of the battery gradually is reduced.

Therefore, a carbon material which can occlude and discharge lithium has recently been used for a negative electrode of a lithium battery.

However, when a lithium battery having a negative electrode comprising a carbon material which can occlude and discharge lithium is stored under a condition of discharge, the negative electrode reacts with a solvent of a nonaqueous electrolyte to increase an electrical potential of the negative electrode and produce gas. Internal pressure is increased and the battery swells. This is a problem especially for a thin lithium battery in which a battery container consists of a laminated film of a metal sheet coated on both sides with a resin. When expansion increases a sealed portion is broken because the strength of such a container is not strong and a nonaqueous electrolyte leaks from the battery.

A negative electrode having a carbon material coated on its surface with a conductive polymer was proposed to prevent decreased capacity caused by the reaction between a negative electrode including a carbon material and a nonaqueous electrolyte as described in Japanese Patent Laid-open Publication No. 4-220948. A negative electrode having a carbon material coated on its surface with polymer comprising a polymer material and an alkali metal salt was also proposed to prevent production of gas from the negative electrode as described in Japanese Patent Laid-open Publication No. 8-306353.

However, when the surface of a carbon material is coated with a conductive polymer, the coated material does not have the capability of charge-discharge, and charge-discharge characteristics of the lithium battery deteriorate.

A negative electrode for a lithium battery having metal-carbon composite particles obtained by burying metal particles in plural carbon phases has been recently proposed to improve capacity and charge-discharge cycle characteristics in a lithium battery as described in Japanese Patent Laid-open Publication No. 2000-272911.

However, when metal-carbon composite particles obtained by burying metal particles in plural carbon phases are used for a negative electrode, a reaction between the negative electrode and the solvent of a nonaqueous electrolyte cannot be sufficiently prevented during storage of the lithium battery under a condition of discharge. Gas is produced and internal pressure is increased to cause expansion of the battery.

### OBJECT OF THE INVENTION

An object of the present invention is to solve the problems described above. Specifically, the present invention intends to improve a negative electrode which includes a carbon material for use in a lithium battery. Furthermore, the present invention intends to inhibit a reaction between the negative electrode and solvent of a nonaqueous electrolyte and to prevent expansion of the battery due to gas produced by reaction during storage of the lithium battery under a condition of discharge. In a thin lithium battery in which a battery container is made of a laminated film of a metal sheet coated on both sides with a resin, the present invention specifically intends to prevent leakage of nonaqueous electrolyte from the battery caused by expansion of the battery.

### SUMMARY OF THE INVENTION

The present invention provides a negative electrode for a lithium battery which is prepared from a mixture of a carbon material capable of occluding and discharging (releasing) lithium and an additive material which contains an element which has a higher average electrical potential for discharging lithium than the carbon material. The additive material is added in an amount of 0.01-9.0 weight % based on the weight of the carbon material. Carbon material having an average particle diameter of 0.01-50 μm is used. The additive material also has an average particle diameter of 0.01-50 μm.

A lithium battery of the present invention is prepared using the negative electrode when positive and negative electrodes and nonaqueous electrolyte are put in a battery container.

### BRIEF DESCRIPTION OF THE DRAWINGS

FIG. 1 is a perspective view of a lithium secondary battery prepared in the Examples of the present invention and the Comparative Examples.

FIGS. 2(A) and 2(B) are cross sections showing the inner structure of a lithium secondary battery prepared in the Examples of the present invention and the Comparative Examples.

FIG. 3 is a graph showing the relationship between voltage and days of storage when the lithium secondary batteries in Example 1 and Comparative Example 1 were stored in an isothermal chamber at 60° C.

The following elements are shown in the drawing:

10: a battery container

11: a laminated film

11a: a metal sheet

11b: a resin

12: a positive electrode

13: a negative electrode

### DETAILED EXPLANATION OF THE INVENTION

When a negative electrode for a lithium battery is prepared from a mixture of a carbon material capable of occluding and discharging lithium and an additive material having a higher average electrical potential for discharging lithium than the carbon material in a range of 0.01-9.0 weight % based on the weight of the carbon material, production of gas caused by a reaction between the negative electrode and a solvent of a nonaqueous electrolyte is prevented even if the lithium battery is stored under a condition of discharge because elevation of the electrical potential of the negative electrode is inhibited by the additive material having a higher average electrical potential for discharging lithium than the carbon material.

Therefore, internal pressure of a lithium battery of the present invention does not increase to cause expansion of the battery. Therefore, when a laminate of a metal sheet coated on both sides with resin is used for a battery container, the sealed part is not broken and there is no leakage of nonaqueous electrolyte.

The reason why an additive material having a higher average electric potential for discharging lithium than the carbon material is added in a range of 0.01-9.0 weight % based on the weight of the carbon material is that a reaction between the negative electrode and a solvent of the nonaqueous electrode during storage of a lithium battery under a condition of discharge cannot be prevented sufficiently if an amount of the additive material is less than 0.01 weight %. If an amount of the additive material is more than 9.0 weight %, charge-discharge efficiency of the negative electrode is reduced and cycle characteristics are deteriorated because charge discharge characteristics of the additive material are inferior to that of the carbon material.

As to the reason for using a carbon material having an average particle diameter of 0.01-50 μm and an additive material having an average particle diameter of 0.01-50 μm in the present invention, if the diameters of the carbon material and the additive material are greater than this range, the carbon material and the additive material are not easily and uniformly mixed. Moreover, cycle characteristics are deteriorated because respective surface areas become smaller and the contact area of the carbon material and the additive material becomes smaller to make load at charge-discharge greater.

A carbon material capable of occluding and discharging lithium, for example, natural graphite, artificial graphite, coke, and calcined organic material, can be used as the carbon material for the negative electrode of the lithium battery. When a high crystalline graphite having a spacing d₀₀₂ of the lattice plane (002) of not greater than 0.3365 nm is used, a lithium battery having excellent charge and discharge capacity and efficiency of charge and discharge can be obtained.

The additive material for the negative electrode for the lithium battery can include any element having a higher average electrical potential for discharging lithium than the carbon material. For example, at least one element selected from the group consisting of Si, Sn, Ge, Mg, Ca, Al, Pb, In, Co, Ag and Pt and the like, can be used.

A lithium battery of the present invention is characterized by using the above-described negative electrode. There is no limitation regarding a positive electrode and a nonaqueous electrolyte, and any of them which are conventionally used for a lithium battery can be used.

The material for the positive electrode is not limited if the material is capable of occluding and discharging lithium. Lithium containing transition metals, for example, LiCoO₂, LiNiO₂, LiMn₂O₄, LiMnO₂, LiCu_{0.5}Ni_{0.5}O₂, LiNi_{0 7}Co_{0 2}Mn_{0.1}O₂ and the like can be used.

As the nonaqueous electrolyte, a nonaqueous electrolyte solution in which a solute is dissolved in a nonaqueous solvent, a gelled polymer electrolyte comprising a polymer such as polyethylene oxide, polyacrylonitrile and the like impregnated with a nonaqueous electrolyte solution, etc. can be used.

As a solvent of the nonaqueous electrolyte, there can be used ethylene carbonate, propylene carbonate, butylene carbonate, vinylene carbonate, cyclopentanone, sulfolane, dimethyl sulfolane, 3-methyl-1,3-oxazolidine-2-one, y-butyrolactone, dimethyl carbonate, diethyl carbonate, methyl ethyl carbonate, methyl propyl carbonate, methyl butyl carbonate, ethyl propyl carbonate, ethyl butyl carbonate, dipropyl carbonate, 1,2-dimethoxy ethane, tetrahydrofuran, 2-methyl tetrahydrofuran, 1,3-dioxolane, methyl acetate and ethyl acetate, alone or as a mixture of two or more of these.

As the solute dissolved in a nonaqueous solvent, there can be used LIPF₆, LIBF, ₄LiCF SO,_{3 3}LiN(CF SO)₃, _{2 2} LIN(C F SO₂)₅, _{2 2} LiN(CF₃SO₂)(C₄F₉SO₂), LiC(CF₃SO₂)₃, LiC(C₂F₅SO₂)₃ and the like, alone or as a mixture of two or more of these.

A lithium battery of the present invention can be a primary or secondary battery.

### DESCRIPTION OF PREFERRED EMBODIMENTS

A negative electrode for a lithium battery and a lithium battery of the present invention are described below in detail in conjunction with certain examples. Comparative examples are also described below to make it clear that the lithium battery having the negative electrode of the present invention prevents production of gas by the reaction of the negative electrode and the nonaqueous electrolyte during storage of the battery and provides sufficient cycle characteristics. It is of course understood that the present invention is not limited to the following examples. The present invention can be modified within the scope and spirit of the appended claims.

### EXAMPLE 1

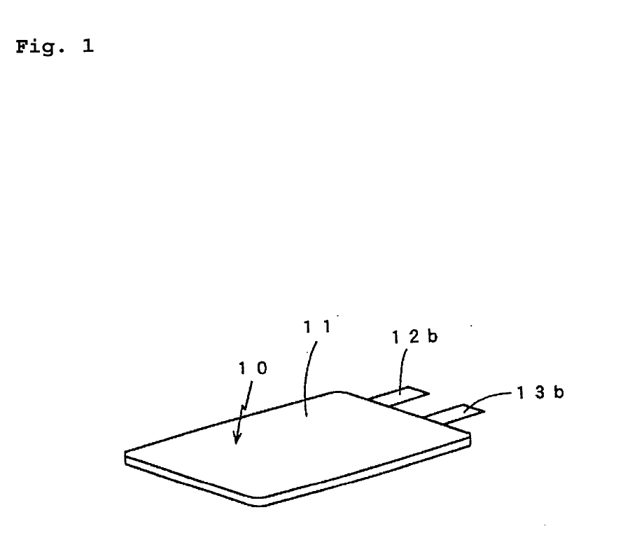

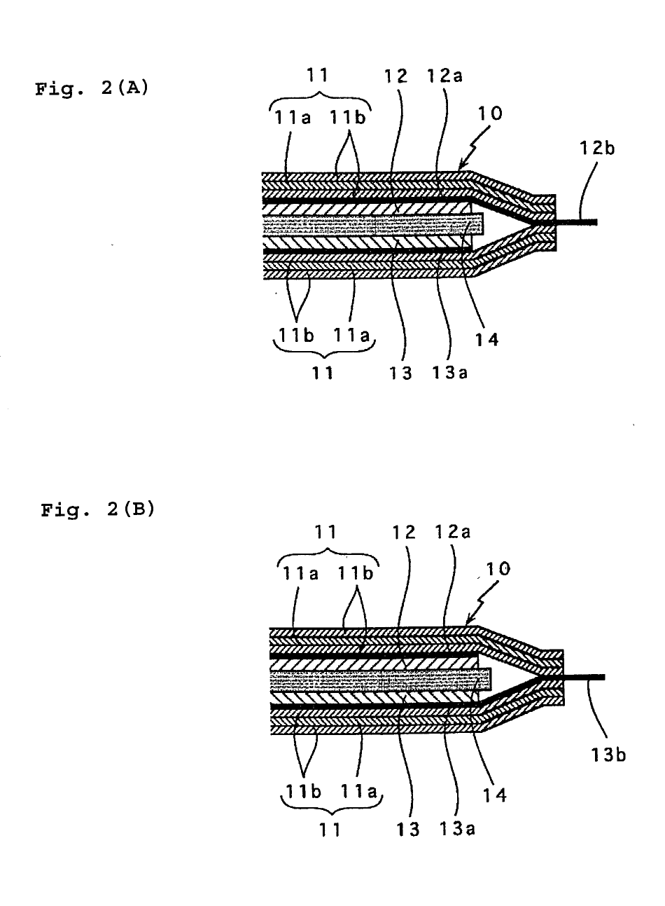

A thin lithium secondary battery as shown in FIGS. 1, 2(A) and 2(B) was prepared using the positive electrode, negative electrode and nonaqueous electrolyte described below.

[Preparation of Positive Electrode]

LiCoO₂ as an active positive electrode material, artificial graphite as an electrically conducting agent and polyfluorovinylidene as a binder were mixed in a ratio of 80:10:10 by weight, and were added to N-methyl-2-pyrrolidone to prepare a slurry. The slurry was coated on a surface of a positive electrode collector of an aluminum foil by a doctor blade, the coated foil was dried by heating at 150° C. for two hours, and the dried foil was cut to 3.5 cm×6.5 cm to prepare a positive electrode.

[Preparation of Negative Electrode]

An artificial graphite powder having an interlayer spacing d₀₀₂ of the lattice plane of 0.3360 nm and an average particle diameter of 20 μm as a carbon material for a negative electrode was used. Si powder having an average particle diameter of 1 μm was used as an additive material comprising an element having a higher average electrical potential for discharging lithium than the carbon material. The artificial graphite powder, the Si powder and polyfluorovinylidene as a binding agent were mixed in a ratio of 99:1:10 by weight, then N-methyl-2-pyrrolidone was added to prepare a slurry. The slurry was coated on a side of a copper film as a negative electrode collector by a doctor blade, the film was dried by heating at 150° C. for two hours and the dry film was cut to 4.0 cm×7.0 cm to prepare a negative electrode. A ratio by weight (X) of the additive material comprising Si powder to the carbon material was 1.0 weight %.

[Preparation of Non-Aqueous Electrolyte]

LiPF₆ was dissolved in a mixture of ethylene carbonate and diethyl carbonate in a ratio of 1:1 by volume to a concentration of 1 mol/l to prepare a nonaqueous electrolyte.

[Preparation of Secondary Battery]

A battery container 10 was prepared using a laminated film 11 in which both sides of a metal sheet 11a were laminated with resin 11b, polypropylene, as shown in FIGS. 2(A) and (B). The positive electrode 12, the negative electrode 13 and a separator 14 made of a porous polyethylene film inserted between the positive and negative electrodes were placed in the battery container 10, and the nonaqueous electrolyte was poured into the container 10. The battery container was sealed by heat fusion such that a positive electrode terminal 12b that is an extended part of the positive electrode collector 12a of the positive electrode 12 extended to the outside of the container 10, and a negative electrode terminal 13b that is an extended part of the negative electrode collector 13a of the negative electrode 13 extended to the outside of the container 10, and a thin lithium secondary battery was prepared.

### EXAMPLE 2

A negative electrode was prepared in the same manner as the preparation of the negative electrode in Example 1 except that artificial graphite powder having an interlayer spacing d₀₀₂ of the lattice plane of 0.3360 nm and an average particle diameter of 20 μm and coke powder having an interlayer spacing d₀₀₂ of the lattice plane of 0.346 nm and an average particle diameter of 10 μm were used as the carbon material for the negative electrode, and the artificial graphite powder, the coke powder, the Si powder and polyfluorovinylidene as a binding agent were mixed in a ratio of 94:5:1:10 by weight. A ratio by weight (X) of the additive material comprising Si powder to the carbon material was also 1.0 weight %.

A lithium secondary battery was prepared in Example 2 in the same manner as Example 1 except that the negative electrode described above was used.

### EXAMPLES 3-12

Negative electrodes were prepared in the same manner as the preparation of the negative electrode in Example 1 except that different additive materials comprising elements having higher average electrical potentials to occlude and discharge lithium than the carbon material as shown in Table 1 were prepared. That is, Sn powder having an average particle diameter of 1 μm in Example 3, Ge powder having an average particle diameter of 1 μm in Example 4, Mg powder having an average particle diameter of 1 μm in Example 5, Ca powder having an average particle diameter of 1 μm in Example 6, Al powder having an average particle diameter of 1 μm in Example 7, Pb powder having an average particle diameter of 1 μm in Example 8, In powder having an average particle diameter of 1 μm in Example 9, Co powder having an average particle diameter of 1 μm in Example 10, Ag powder having an average particle diameter of 1 μm in Example 11 and Pt powder having an average particle diameter of 1 μm in Example 12 were used. A ratio by weight of each of the additive material to the carbon material (X) was also 1.0 weight %.

A lithium secondary battery was prepared in Examples 3-12 in the same manner as Example 1 except that the negative electrode described above was used.

### COMPARATIVE EXAMPLE 1

A negative electrode was prepared in the same manner as the negative electrode in Example 1 except that Si powder was not added and artificial graphite powder having an interlayer spacing d₀₀₂ of the lattice plane of 0.3360 nm and an average particle diameter of 20 μm and polyfluorovinylidene as a binding agent were mixed in a ratio of 100:10 by weight.

A lithium secondary battery was prepared in Comparative Example 1 in the same manner as Example 1 except that the negative electrode described above was used.

Each of the lithium secondary batteries prepared in Examples 1-13 and Comparative Example 1 was charged to 4.2 V at a constant charging current of 10 mA, and constantly discharged to 2.7 V at a constant discharging current of 10 mA (this cycle is considered as one cycle). Five cycles were repeated. A charge capacity at the first cycle (Qa1), a discharge capacity at the first cycle (Qb1) and a discharge capacity at the fifth cycle (Qb5) were measured. An initial charge-discharge efficiency (%) was calculated as follows:

Initial charge-discharge efficiency (%)=(Qb1/Qa1)×100

Each of the lithium secondary batteries prepared in Examples 1-13 and Comparative Example 1 was charged to 4.2 V at a constant charging current of 10 mA, and constantly discharged to 2.7 V at a constant discharging current of 10 mA, and then was stored in an isothermal chamber at 60° C. for 20 days. A voltage of each lithium secondary battery was measured after storage, and the condition of each battery was evaluated. The results are shown in Table 1.

Condition of the batteries was evaluated as to whether or not there was expansion of the battery or leaking solution. When the battery had no expansion of the battery or leaking solution, condition is identified as Ω, and when there was expansion of the battery or leaking solution, the condition is identified as X in Table 1.

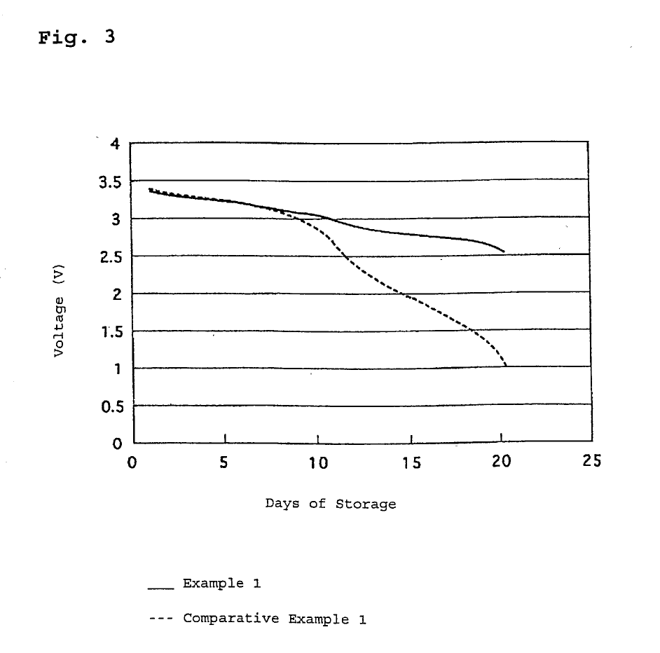

Each lithium secondary battery in Example 1 and Comparative Example 1 was examined to determine the relationship between voltage and storage days in an isothermal chamber at 60° C. The results are shown in FIG. 3. The results of the lithium battery in Example 1 are shown by a solid line and the results of the lithium battery in Comparative Example 1 are shown by a dotted line.

TABLE
X = 1.0 wt %, Artificial graphite (AG) 20 μm, Coke (C) 10 μm, Additive material 1 μm

| | | | | | | Initial | | |
|---|---|---|---|---|---|---|---|---|
| | | | | | | charge | After storage | |
| | | | | | | discharge | | Evaluation |
| | Carbon | | Qa 1 | Qb 1 | Qb 5 | efficiency | Voltage | of |
| | material | Additives | (mAh) | (mAh) | (mAh) | (%) | (V) | condition |
| Ex. 1 | AG | Si | 50 | 45 | 45 | 90.0 | 2.7 | ◯ |
| Ex. 2 | AG & C | Si | 50 | 44 | 44 | 88.0 | 2.6 | ◯ |
| Ex. 3 | AG | Sn | 50 | 45 | 45 | 90.0 | 2.5 | ◯ |
| Ex. 4 | AG | Ge | 50 | 45 | 45 | 90.0 | 2.5 | ◯ |
| Ex. 5 | AG | Mg | 50 | 45 | 45 | 90.0 | 2.4 | ◯ |
| Ex. 6 | AG | Ca | 50 | 45 | 45 | 90.0 | 2.3 | ◯ |
| Ex. 7 | AG | Al | 50 | 45 | 45 | 90.0 | 2.3 | ◯ |
| Ex. 8 | AG | Pb | 50 | 45 | 45 | 90.0 | 2.4 | ◯ |
| Ex. 9 | AG | In | 50 | 45 | 45 | 90.0 | 2.4 | ◯ |
| Ex. 10 | AG | Co | 50 | 45 | 45 | 90.0 | 2.3 | ◯ |
| Ex. 11 | AG | Ag | 50 | 45 | 45 | 90.0 | 2.4 | ◯ |
| Ex. 12 | AG | Pt | 50 | 45 | 45 | 90.0 | 2.4 | ◯ |
| Comp. | AG | — | 49 | 45 | 45 | 91.8 | 1.0 | X |
| Ex. 1 | | | | | | | | |

There were no significant differences relating to charge capacity at the first cycle (Qa1), discharge capacity at the first cycle (Qb1) and a discharge capacity at the fifth cycle (Qb5) in each of the secondary batteries of Examples 1-13 and Comparative Example 1. After storage of the batteries in an isothermal chamber at 60° C. for 20 days, there was hardly any reduction of voltage and no expansion of the battery or leakage of solution in the lithium secondary batteries of Examples 1-13. However, the lithium secondary battery of Comparative Example 1 had significantly reduced voltage and showed expansion of the battery and leakage of solution after storage.

As shown in FIG. 3, the lithium secondary battery of Example 1 did not have a reduction of voltage after storage of the battery in an isothermal chamber at 60° C. for 20 days as compared to the battery of Comparative Example 1.

When the lithium secondary battery of Example 1, in which only the artificial graphite powder having an interlayer spacing d₀₀₂ of the lattice plane of 0.3360 nm was used, is compared to the lithium secondary battery of Example 2, in which the artificial graphite powder having an interlayer spacing d₀₀₂ of the lattice plane of 0.3360 nm and the coke powder having an interlayer spacing d₀₀₂ of the lattice plane of 0.346 nm and an average particle diameter of 10 μm were used, the lithium secondary battery of Example 1 had a higher initial charge discharge efficiency and a greater discharge capacity at the fifth cycle (Qb5).

### EXAMPLES A1-A4 AND COMPARATIVE EXAMPLE a1

Negative electrodes were prepared in the same manner as the negative electrode in Example 1 except that the mixture ratio of the artificial graphite powder and Si powder was changed. A ratio of the artificial graphite powder and Si powder was 99.99:0.01 in Example A1, a ratio of the artificial graphite powder and Si powder was 99.50:0.50 in Example A2, a ratio of the artificial graphite powder and Si powder was 95.24:4.76 in Example A3, a ratio of the artificial graphite powder and Si powder was 91.75:8.25 in Example A4, and a ratio of the artificial graphite powder and Si powder was 91:9 in Comparative Example a1. Ratios by weight of the additive material, Si powder, to the carbon material (X) were 0.01 weight % in Example A1, 0.05 weight % in Example A2, 0.5 weight % in Example A3, 9.0 weight % in Example A4, and 9.9 weight % in Comparative Example a1 as shown in Table 2.

Each lithium secondary battery in Examples A1-A4 and Comparative Example a1 was prepared in the same manner as Example 1 except that the negative electrode described above was used.

A charge capacity at the first cycle (Qa1), a discharge capacity at the first cycle (Qb1) and a discharge capacity at the fifth cycle (Qb5) were measured for each lithium secondary battery of Examples A1-A4 and Comparative Example a1 in the same manner as Examples 1-13. An initial charge-discharge efficiency (%) was also calculated for each lithium secondary battery. A voltage of each lithium secondary battery was measured after storage in an isothermal chamber at 60° C. for 20 days, and the condition of each battery was also evaluated. The results are shown in Table 2.

TABLE 2
Carbon material: Artificial graphite 20 μm, Additive material: Si powder 1 μm

| | | | | | Initial | | |
|---|---|---|---|---|---|---|---|
| | | | | | charge | After storage | |
| | | | | | discharge | | Evaluation |
| | X | Qa1 | Qb1 | Qb5 | efficiency | Voltage | of |
| | (wt %) | (mAh) | (mAh) | (mAh) | (%) | (V) | condition |
| Ex. A1 | 0.01 | 49 | 45 | 45 | 91.8 | 2.6 | ◯ |
| Ex. A2 | 0.05 | 50 | 45 | 45 | 90.0 | 2.7 | ◯ |
| Ex. 1 | 1.0 | 50 | 45 | 45 | 90.0 | 2.7 | ◯ |
| Ex. A3 | 5.0 | 51 | 45 | 45 | 88.2 | 2.7 | ◯ |
| Ex. A4 | 9.0 | 52 | 45 | 45 | 86.5 | 2.7 | ◯ |
| Comp. Ex. a1 | 9.9 | 55 | 45 | 20 | 81.8 | 2.7 | ◯ |

After storage of the batteries in an isothermal chamber at 60° C. for 20 days, there was not a significant reduction of voltage and there was no expansion of the battery or leakage of solution in the lithium secondary batteries of Examples A1-A4 and Comparative Example a1. However, the lithium secondary battery of Comparative Example a1 in which Si powder as the additive agent is more than 9.0 weight % had a lower initial charge-discharge efficiency and discharge capacity at the fifth cycle compared to the lithium secondary batteries of Examples A1-A4. Cycle characteristics of the lithium secondary battery of Comparative Example a1 were not as good as that of the lithium secondary batteries of Examples A1-A4.

Although Si powder was used as the additive material in the above described Examples A1-A4 and Comparative Example a1, when Sn powder, Ge powder, Mg powder, Ca powder, Al powder, Pb powder, In powder, Co powder, Ag powder and Pt powder are used instead of Si powder, the same results are obtained.

### EXAMPLES B1-B4 AND COMPARATIVE EXAMPLE b1

Negative electrodes were prepared in the same manner as the preparation of the negative electrode in Example 1 except that Si powder having different average particle diameters were used as a additive material as shown in Table 3. That is, Si powder having an average particle diameter of 3 μm in Example B1, Si powder having an average particle diameter of 5 μm in Example B2, Si powder having an average particle diameter of 10 μm in Example B3, Si powder having an average particle diameter of 50 μm in Example B4 and Si powder having an average particle diameter of 60 μm in Comparative Example b1 were used.

Each lithium secondary battery in Examples B1-B4 and Comparative Example b1 was prepared in the same manner as Example 1 except that the negative electrode described above was used.

A charge capacity at the first cycle (Qa1), a discharge capacity at the first cycle (Qb1) and a discharge capacity at the fifth cycle (Qb5) were measured for each lithium secondary battery of Examples A1-A4 and Comparative Example a1 in the same manner as Examples 1-13. An initial charge discharge efficiency (%) was also calculated for each lithium secondary battery. A voltage of each lithum secondary battery was measured after storage in an isothermal chamber at 60° C. for 20 days, and the condition of each battery was also evaluated. The results are shown in Table 3.

TABLE 3
Carbon material: Artificial graphite 20 μm, X = 1.0 wt %

| | Average | | | | Initial | | |
|---|---|---|---|---|---|---|---|
| | diameter | | | | charge | After storage | |
| | of Si | | | | discharge | | Evaluation |
| | powder | Qa1 | Qb1 | Qb5 | efficiency | Voltage | of |
| | (μm) | (mAh) | (mAh) | (mAh) | (%) | (V) | condition |
| Ex. 1 | 1 | 50 | 45 | 45 | 90.0 | 2.7 | ◯ |
| Ex. B1 | 3 | 50 | 45 | 45 | 90.0 | 2.7 | ◯ |
| Ex. B2 | 5 | 50 | 45 | 45 | 90.0 | 2.7 | ◯ |
| Ex. B3 | 10 | 50 | 45 | 45 | 90.0 | 2.7 | ◯ |
| Ex. B4 | 50 | 50 | 45 | 44 | 90.0 | 2.7 | ◯ |
| Comp. Ex. b1 | 60 | 50 | 45 | 30 | 90.0 | 2.7 | ◯ |

After storage of the batteries in an isothermal chamber at 60° C. for 20 days, there was not a significant reduction of voltage and there was no expansion of the battery or leakage of solution in the lithium secondary batteries of Examples B1-B4 and Comparative Example b1. However, the lithium secondary battery of Comparative Example b1 in which the average particle diameter of the Si powder is 60 μm had a lower discharge capacity at the fifth cycle compared to the lithium secondary batteries of Examples B1-B4. Cycle characteristics of the lithium secondary battery of Comparative Example b1 were not as good as that of the lithium secondary batteries of Examples B1-B4.

Although Si powder was used as the additive material in the above described Examples B1-B4 and Comparative Example b1, when Sn powder, Ge powder, Mg powder, Ca powder, Al powder, Pb powder, In powder, Co powder, Ag powder and Pt powder are used instead of Si powder, the same results are obtained.

### EXAMPLES C1-C4 AND COMPARATIVE EXAMPLE c1

Negative electrodes were prepared in the same manner as the preparation of the negative electrode in Example 1 except that artificial graphite powder having different average particle diameters as shown in Table 4 were used. That is, artificial graphite powder having an average particle diameter of 3%m in Example C1, artificial graphite powder having an average particle diameter of 5%m in Example C2, artificial graphite powder having an average particle diameter of 10 μm in Example C3, artificial graphite powder having an average particle diameter of 50 μm in Example C4 and artificial graphite powder having an average particle diameter of 60 μm in Comparative Example c1 were used.

Each lithium secondary battery in Examples C1-C4 and Comparative Example c1 was prepared in the same manner as Example 1 except that the negative electrode described above was used.

A charge capacity at the first cycle (Qa1), a discharge capacity at the first cycle (Qb1) and a discharge capacity at the fifth cycle (Qb5) were measured for each lithium secondary battery of Examples A1-A4 and Comparative Example a1 in the same manner as Examples 1-13. An initial charge discharge efficiency (%) was also calculated for each lithium secondary battery. A voltage of each lithum secondary battery was measured after storage in an isothermal chamber at 60° C. for 20 days, and the condition of each battery was also evaluated. The results are shown in Table 4.

TABLE 4
Additive material: Si powder 1 μm, X = 1.0 wt %

| | Average | | | | | | |
|---|---|---|---|---|---|---|---|
| | diameter | | | | Initial | | |
| | of | | | | charge | After storage | |
| | artificial | | | | discharge | | Evaluation |
| | graphite | Qa1 | Qb1 | Qb5 | efficiency | Voltage | of |
| | (μm) | (mAh) | (mAh) | (mAh) | (%) | (V) | Condition |
| Ex. C1 | 3 | 50 | 45 | 45 | 90.0 | 2.7 | ◯ |
| Ex. C2 | 5 | 50 | 45 | 45 | 90.0 | 2.7 | ◯ |
| Ex. C3 | 10 | 50 | 45 | 45 | 90.0 | 2.7 | ◯ |
| Ex. 1 | 20 | 50 | 45 | 45 | 90.0 | 2.7 | ◯ |
| Ex. C4 | 50 | 50 | 45 | 45 | 90.0 | 2.6 | ◯ |
| Comp. Ex. c1 | 60 | 50 | 30 | 30 | 60.0 | 2.7 | ◯ |

After storage of the batteries in an isothermal chamber at 60° C. for 20 days, there was not a significant reduction of voltage and was no expansion of the battery or leakage of solution in the lithium secondary batteries of Examples C1-C4 and Comparative Example c1. However, the lithium secondary battery of Comparative Example c1 in which the average particle diameter of artificial graphite powder was 60 μm had a lower initial charge efficiency and discharge capacity at the fifth cycle as compared to the lithium secondary batteries of Examples C1-C4. Cycle characteristics of the lithium secondary battery of Comparative Example c1 are not as good as that of the lithium secondary batteries of Examples C1-C4.

Although Si powder was used as the additive material in the above described Examples C1-C4 and Comparative Example c1, when Sn powder, Ge powder, Mg powder, Ca powder, Al powder, Pb powder, In powder, Co powder, Ag powder and Pt powder are used instead of Si powder, the same results are obtained.

### ADVANTAGES OF THE INVENTION

A lithium battery of the present invention includes a negative electrode made of a mixture of a carbon material capable of occluding and discharging (releasing) lithium and an additive material containing an element having a higher average electrical potential than the carbon material. Therefore, electrical potential of the negative electrode is inhibited to prevent production of gas by reaction of the negative electrode and a solvent of the nonaqueous electrolyte.

As a result, internal pressure of a lithium battery of the present invention does not increase to expand the battery. Therefore, when a laminate of a metal sheet coated on both sides with resin is used for a battery container, the sealed part is not broken and there is no leakage of nonaqueous electrolyte.

A lithium battery of the present invention includes an amount of the additive material of 0.01-9.0 weight % based on the weight of the carbon material. Charge discharge efficiency of the negative electrode is not reduced, and cycle characteristics are not deteriorated when the carbon material having an average particle diameter of 0.01-50 μm and the additive material also having an average particle diameter of 0.01-50 μm are used in the present invention. The present invention is particularly useful for a secondary battery.

What is claimed is:

1. A negative electrode for a lithium battery comprising a carbon material capable of occluding and discharging lithium and an additive material having a higher potential for discharging lithium than said carbon material, wherein said additive material is contained in a range of 0.01-9.0 weight % based on the weight of said carbon material, an average particle diameter of said carbon material is in a range of 0.01-50 μm, and an average particle diameter of said additive material is in a range of 0.01-50 μm.

2. The negative electrode for a lithium battery according to claim 1, wherein said additive material is at least one element selected from the group consisting of Si, Sn, Ge, Mg, Ca, Al, Pb, In, Co, Ag and Pt.

3. The negative electrode for a lithium battery according to claim 1, wherein said carbon material has a spacing d₀₀₂ of the lattice plane (002) of not greater than 0.3365 nm.

4. A lithium battery comprising a positive electrode, a negative electrode and a nonaqueous electrolyte in a battery container, wherein the negative electrode comprises a carbon material capable of occluding and discharging lithium and an additive material having a higher potential for discharging lithium than said carbon material, wherein said additive material is contained in a range of 0.01-9.0 weight % based on the weight of said carbon material, an average particle diameter of said carbon material is in a range of 0.01-50 μm, and an average particle diameter of said additive material is in a range of 0.01-50 μm.

5. The lithium battery according to claim 4, wherein said additive material is at least one element selected from the group consisting of Si, Sn, Ge, Mg, Ca, Al, Pb, In, Co, Ag and Pt.

6. The lithium battery according to claim 4, wherein said carbon material has a spacing d₀₀₂ of the lattice plane (002) of not greater than 0.3365 nm.

7. The lithium battery according to claim 4, further comprising a battery container which comprises a laminated film of a metal sheet coated on both sides with a resin.

8. The lithium battery according to claim 5, further comprising a battery container which comprises a laminated film of a metal sheet coated on both sides with a resin.

9. The lithium battery according to claim 6, further comprising a battery container which comprises a laminated film of a metal sheet coated on both sides with a resin.
